(19) United States
(12) Patent Application Publication
(10) Pub. No.: US 2008/0055189 A1
(43) Pub. Date: Mar. 6, 2008

(54) System and Method for Displaying Computer Data in a Multi-Screen Display System

(76) Inventors: Raymond Richard Wilk, Toronto (CA); Allan Tameshtit, Toronto (CA)

Correspondence Address: Ray Wilk, 474 Wellington Street West, Toronto, ON, M5V 1E3, CA

(21) Appl. No.: 11/843,191

(22) Filed: Aug. 22, 2007

Related U.S. Application Data
(60) Provisional application No. 60/841,305, filed on Aug. 23, 2006.

(51) Int. Cl. G09G 5/00

(52) U.S. Cl. 345/1.3

(57) ABSTRACT

Described herein is a graphics apparatus for displaying video data on a display system having N monitors each containing a screen. The apparatus includes a central controller for receiving from a graphics card a video signal. The central controller divides at least a portion of the video signal into N video streams, each video stream sent to an associated one of the N monitors for producing images on the N screens.

### FIELD OF THE INVENTION

The invention relates to multi-screen display systems, and more particularly to graphics and monitor control in such systems.

### BACKGROUND OF THE INVENTION

The number of multi-monitor or multi-screen computer display systems has increased in recent years as computer users in various industries adapt their use to new environments. For example, a multi-screen display system can be used to create the illusion of a larger screen, thereby allowing a securities trader to view a large single spreadsheet over several displays. Alternately, the trader may view individual applications on individual screens (for example, one screen may display a Web browser, a second a new service and a third a spreadsheet of financial data).

Individuals working with still or moving images, such as graphics artists, video or film editors, and medical diagnosticians may also use multi-screen display systems. A given image may be viewed across several screens, or two images may be viewed side-by-side (such as two x-ray images used to assess the extent to which a broken bone has healed). Although the potential uses for multi-screen display systems appear to be limited only by the user's imagination, a significant barrier arises when a user of a single-screen computer system wishes to upgrade to a multi-screen system. In addition to acquiring the additional monitors for the upgrade, the user typically also has to replace or add graphics cards suitable for use in a multi-screen display system.

For an N-screen display system, N graphics card ports should be available. For example, a single N-port graphics card or N single-port graphics cards can be used. Each of the N ports is connected via a cable to an associated one of the N monitors. In particular, each cable is connected to a controller residing in a monitor.

Thus, if a computer system has only one graphics card with one port, extra ports have to he provided by replacing the graphics card and/or adding graphics cards. This replacement or addition, although time consuming and costly, can sometimes be implemented. However, in other systems, notably laptops or notebooks, there may not he enough space in the laptop or notebook housing to accommodate more than one graphics port or graphics card.

Thus, for laptops with one single-port graphics card, a conventional solution is to add a bus extender that allows the addition of an external graphics card with multiple ports. However, the use of such an extender is associated with some problems, such as compatibility issues between graphics card and laptop hardware.

There is therefore a need for a system that effectively augments the number of available graphics ports in PC's, and, especially, laptops and notebooks for use with multi-screen display systems.

### SUMMARY OF THE INVENTION

Described herein is a multi-screen graphics apparatus for displaying video data on a display system having N>1 screens with respective native resolutions R₁, . . . , R_{N}. The apparatus includes N monitor controllers, each monitor controller associated with one of the N screens for controlling images displayed thereon, and a replicator. The replicator a) receives from a graphics card a video signal, b) replicates at least a portion of the video signal to produce N sets of video data, and c) sends each of the N sets of video data to an associated one of the N monitor controllers for processing to produce images on the N screens. The video signal and each of the N sets of video data correspond to an effective resolution that is greater than any one of R₁, . . . and R_{N}.

Also described herein is an apparatus for displaying video data on a display system having N>1 monitors each containing a screen, the respective native resolutions of the N screens being R₁, . . . , R_{N}. The apparatus includes a central controller for receiving from a graphics card a video signal corresponding to an effective resolution that is greater than any one of R₁, . . . and R_{N}. The central controller divides at least a portion of the video signal into N video streams, each video stream sent to an associated one of the N monitors for producing images on the N screens.

### BRIEF DESCRIPTION OF THE DRAWINGS

FIGS. 1A and 1B show block diagrams of two types of conventional computer systems having a single monitor.

FIG. 2 shows a block diagram of a computer system having a multi-screen graphics apparatus and a display system, in accordance with the principles of the present invention.

FIGS. 3A and 3B respectively show the front and back of the display system of FIG. 2.

FIG. 4 shows a block diagram of the multi-screen graphics apparatus of FIG. 2.

FIG. 5 shows a block diagram of a computer system having a multi-screen graphics apparatus and a display system, in accordance with the principles of the present invention.

FIGS. 6A and 6B respectively show the front and back of the display system of FIG. 5.

FIG. 7 shows a block diagram of the multi-screen graphics apparatus of FIG. 5.

FIG. 8 shows a block diagram of a computer system having a multi-screen graphics apparatus and a display system, in accordance with the principles of the present invention.

FIGS. 9A and 9B respectively show the front and back of the display system of FIG. 8.

FIG. 10 shows a block diagram of the multi-screen graphics apparatus of FIG. 8.

FIG. 11 shows a block diagram of a computer system having a multi-screen graphics apparatus and a display system, in accordance with the principles of the present invention.

FIGS. 12A and 12B respectively show the front and back of the display system of FIG. 11.

FIG. 13 shows a block diagram of the multi-screen graphics apparatus of FIG. 11.

FIG. 14 shows one embodiment of the central controller of FIGS. 11 and 13.

FIG. 15 shows a block diagram of a computer system having a multi-screen graphics apparatus and a display system, in accordance with the principles of the present invention.

FIG. 16 shows the display system of FIG. 15.

FIG. 17 shows a block diagram of the multi-screen graphics apparatus of FIG. 15.

FIG. 18 shows one embodiment of a central controller for a four-screen display system, according to the principles of the present invention.

### DETAILED DESCRIPTION OF THE INVENTION

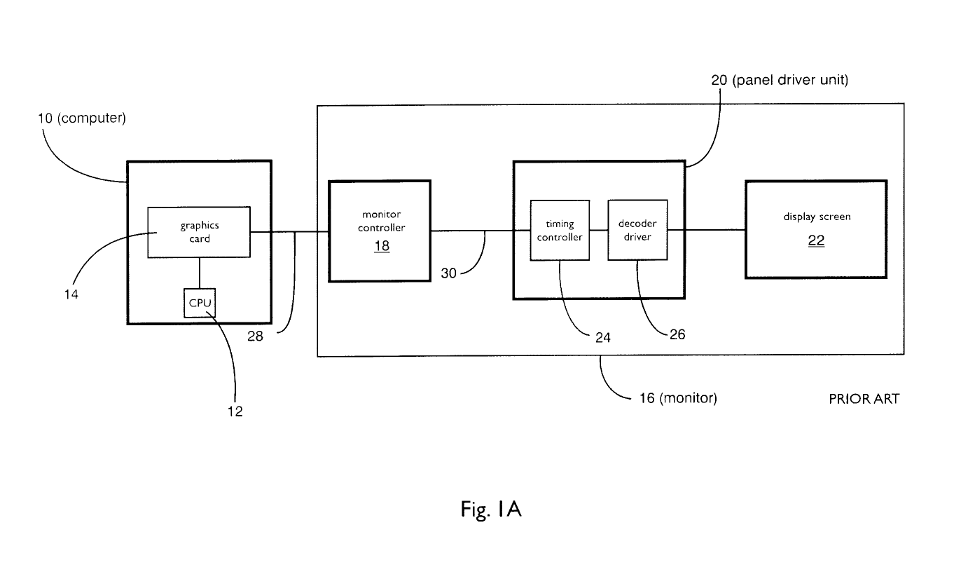

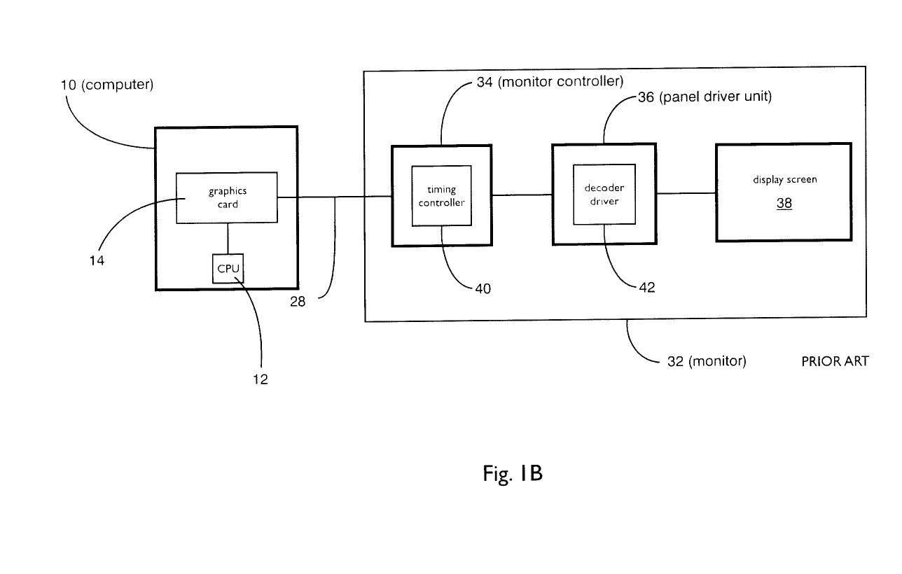

FIGS. 1A and 1B show block diagrams of two types of conventional computer systems having a single monitor. In the type of computer system shown in FIG. 1A, a computer 10, containing a central processing unit (CPU) 12 and a graphics card 14, is connected to a monitor 16, containing a monitor controller 18, a panel driver unit 20 and a display screen 22. The panel driver unit 20 includes a timing controller (TCON) 24 and a decoder driver 26.

The graphics card 14 is connected to the monitor controller 18 via a cable 28 capable of carrying controller signals such as VGA, DVI, HDMI or DisplayPort™ signals. As used herein, controller signals are signals that can be received by a monitor controller for processing. In conventional systems, controller signals are output by the graphics card 14 and sent to the monitor controller 18, and, moreover, adhere to a particular industry standard. The monitor controller 18 receives the controller signals from the graphics card 14 and processes the signal for displaying an image on the display screen 22. In addition, the monitor controller 18 can send power signals to the screen 22, and power and control signals to a backlight inverter (not shown) for powering a backlight (not shown). An example of a commercially available monitor controller is model SVH-1920, from Digital View™, Inc. of Morgan Hill, Calif.

The monitor controller 18 sends low voltage differential signals (LVDS) to the TCON 24 via cables 30. The TCON 24 sends reduced-swing differential signals (RSDS) signals to the decoder driver 26. The decoder driver 26 sends appropriate electrical signals via a grid of electrodes to the display screen 22, such as an LCD, plasma or OLED panel for producing an image on the screen. An example of a commercially available decoder driver for LCD screens is Display Driver IC, Part Number S6C2103 from Samsung™, Inc.

FIG. 1B shows another type of conventional computer system, dubbed a “smart panel system.” In this type of system, the TCON appears in the monitor controller, instead of in the panel driver unit. Thus, a smart panel system includes the computer 10 containing the central processing unit (CPU) 12 and the graphics card 14. The computer 10 is connected to a monitor 32, containing a monitor controller 34, a panel driver unit 36 and a display screen 38. The monitor controller 34 includes a TCON 40. The panel driver unit 36 includes a decoder driver 42.

The graphics card 14 is connected to the monitor controller 34 via the cable 28 capable of carrying controller signals, such as VGA, DVI, HDMI or DisplayPort signals. The monitor controller 34 receives the controller signals from the graphics card 14 and processes the signal for displaying an image on the display screen 38. An example of a commercially available monitor controller containing a TCON is Part Number gm5626 from Genesis™ Microchip Inc.

The monitor controller 34 sends reduced-swing differential signals (RSDS) signals to the panel driver unit 36. The panel driver unit 36 sends appropriate electrical signals via a grid of electrodes to the display screen 38, such as an LCD, plasma or OLED panel for producing an image on the screen.

LVDS and RSDS are examples of panel signals. As used herein, panel signals are signals that can be received by either a timing controller or a decoder driver. In the type of system shown in FIG. 1A, panel signals in the form of LVDS are used to send information from the monitor controller 18 to the TCON 24 in the panel driver unit 20. In the smart panel type of system shown in FIG. 1B, panel signals in the form of RSDS are used to send information from the TCON 40 in the monitor controller 34 to the decoder driver 42 in the panel driver unit 36.

In both types of systems, extended display identification data (EDID) are provided by the monitor to the graphics card to describe the characteristics of the monitor to the graphics card. EDID is defined by a standard published by the Video Electronics Standards Association (VESA). The EDID can include manufacturer name, product type, phosphor or filter type, timings supported by the monitor, resolution, luminance data and pixel mapping data. For example, a monitor with a native resolution of 1280×1024 pixels, a common resolution of commercially available monitors, sends identification data to the graphics card that includes a specification of this native resolution. The graphics card consequently outputs video data appropriate for such a resolution.

When the computer system has N-screens, instead of just one as shown in FIGS. 1A and 1B, N-cables connect one N-port graphics card, or N one-port graphics cards, to N monitors. Principles similar to those described above in connection with a one-screen display system are used, mutatis mutandis, in a conventional N-screen display system.

Because PC's, notebooks and laptops have limited number of graphics ports, the number of screens that can be supported by such conventional systems is limited, often to just one. A computer system having a multi-screen display system is described below that addresses this shortcoming. The computer system includes a multi-screen graphics apparatus that enables even a one-port graphics card to support the multi-screen display system.

Several examples are provided below of such a computer system that conforms to the teachings of the present invention. In examples 1, 2 and 3 below, the multi-screen graphics apparatus includes a replicator for replicating at least a portion of the video signal produced by the graphics card. In examples 4 and 5 below, the multi-screen graphics apparatus functions without the use of a replicator.

In example 1, the multi-screen graphics apparatus includes a plurality of monitor controllers, one for each monitor in the display system. Each monitor, however, lacks a monitor controller normally included therein. In example 2, the multi-screen graphics apparatus also includes monitor controllers, but these are located in the monitors. In example 3, both the multi-screen graphics apparatus and the monitors include monitor controllers.

In example 4, the multi-screen graphics apparatus includes one central controller. Each monitor, however, lacks a monitor controller normally included therein. In example 5, the multi-screen graphics apparatus includes a central controller, and each monitor includes a monitor controller.

In examples 1-5, principles of the present invention are elucidated using a two-screen display system. It should be understood that this restriction is employed merely to simplify the presentation. The principles of the present invention are equally applicable to an N-screen display system, where N is any integer greater than 1.

### EXAMPLE 1

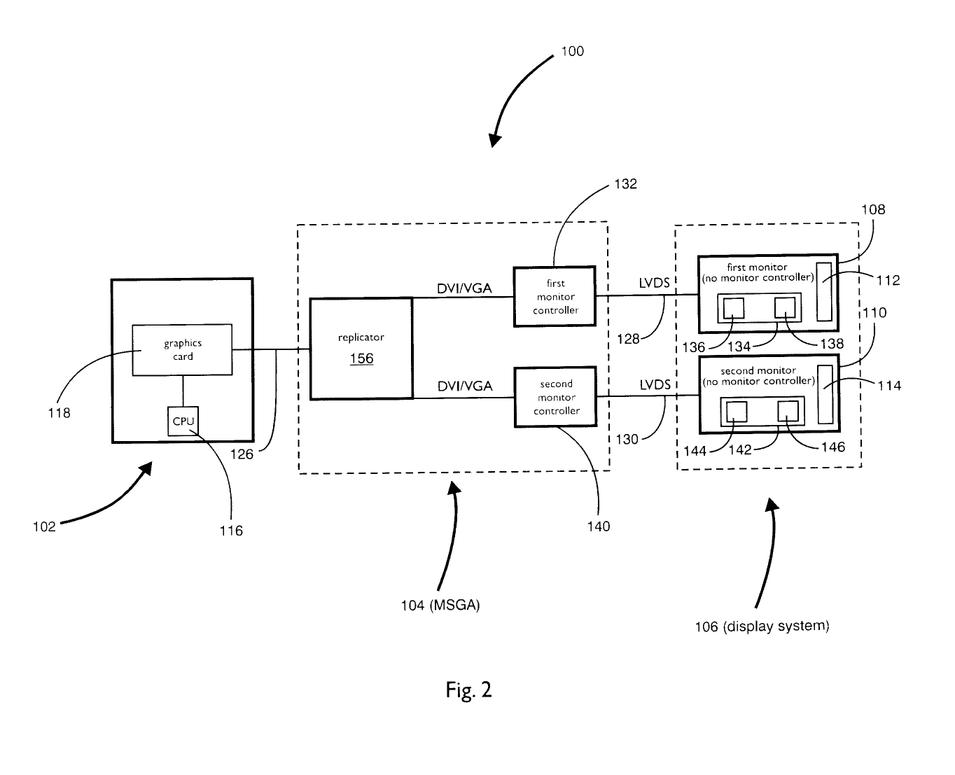

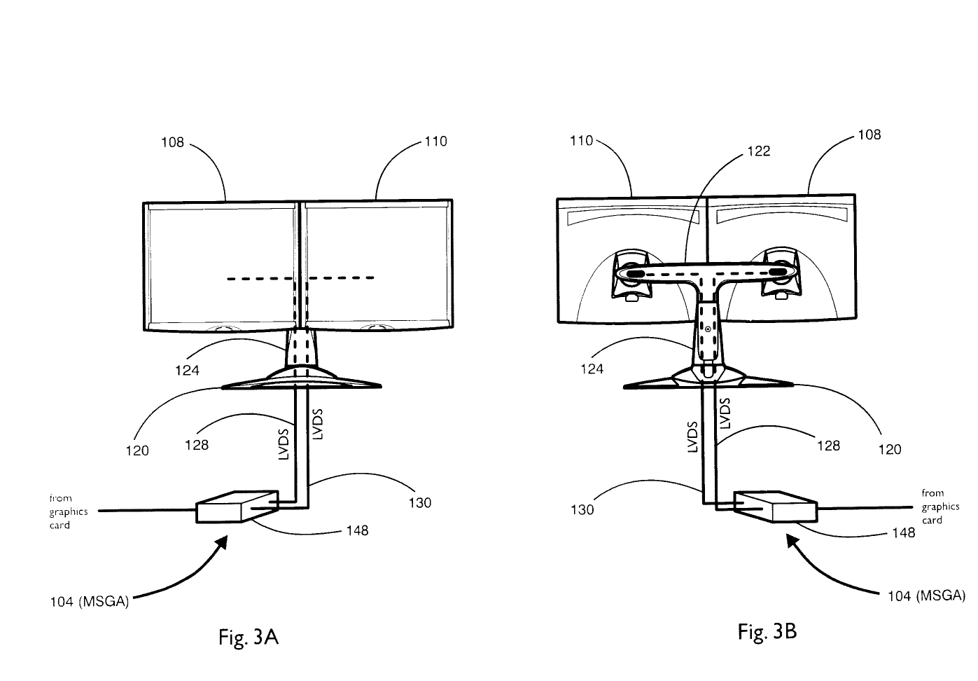

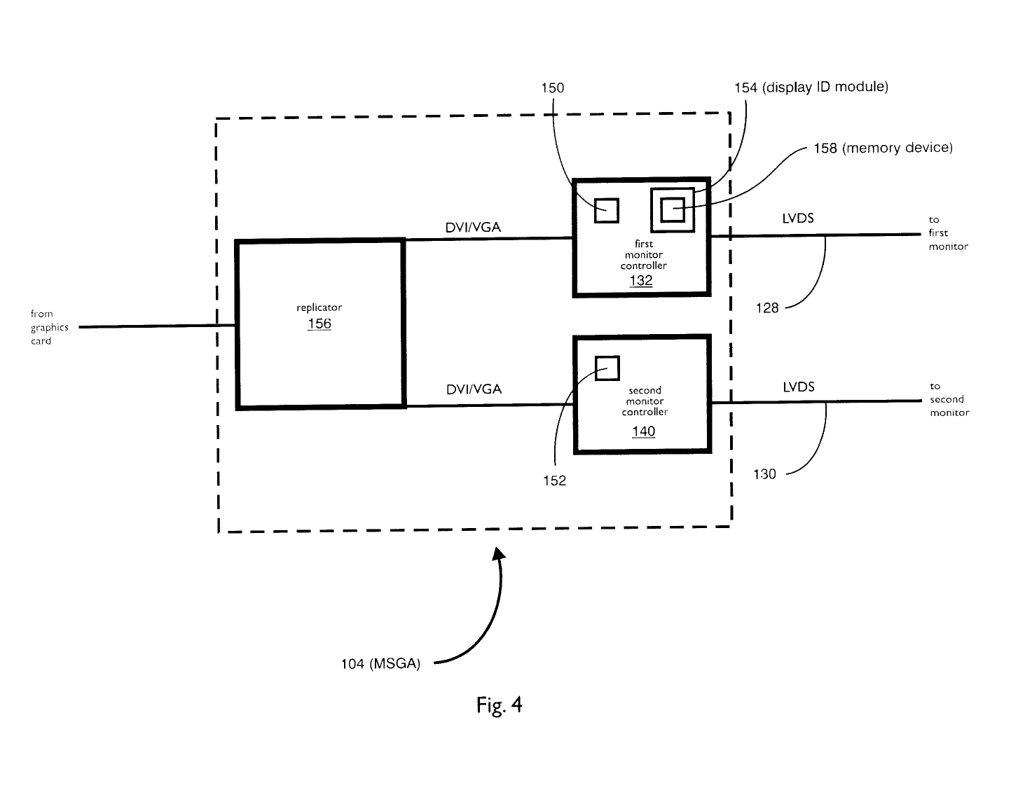

Reference is now made to FIGS. 2, 3A, 3B and 4. FIG. 2 shows a block diagram of a computer system 100 having a computer 102, a multi-screen graphics apparatus 104, and a display system 106 having a first monitor 108 and a second monitor 110, in accordance with the principles of the present invention. FIGS. 3A, 3B and 4 respectively show the front and back of the display system 106, and a block diagram of the multi-screen graphics apparatus 104 of FIG. 2. The first monitor 108 includes a first screen 112 with a first native resolution, R₁, and the second monitor 110 includes a second screen 114 with a second native resolution, R₂. The computer 102 can include a laptop, notebook or PC having a central processing unit 116 and a graphics card 118. The display system 106 includes a base 120, an arm 122 for supporting the first monitor 108 and the second monitor 110, and a column 124 for connecting the base 120 to the arm 122. As described in detail below, the multi-screen graphics apparatus 104 allows video data to be displayed in the two-screen display system 106, even if the graphics card 118 has only one graphics port. The graphics card 118 is connected to the multi-screen graphics apparatus 104 with one cable 126 carrying controller signals, such as VGA or DVI signals. The multi-screen graphics apparatus 104 is connected to the first monitor 108 and to the second monitor 110 with a first cable 128 and a second cable 130, respectively, that carry panel signals, such as LVDS signals.

In particular, a first monitor controller 132 of the multi-screen graphics apparatus 104 sends panel signals to a first panel driver unit 134 of the first monitor 108. In one embodiment, the first panel driver unit 134 includes a TCON 136 and a driver decoder 138 connected thereto. The panel signals are sent from the first monitor controller 132 to the TCON 136 of the first panel driver unit 134 using panel signals. In a second embodiment (not shown), similar to smart panel systems, a first panel driver unit includes a decoder driver, but a TCON is relocated to a first monitor controller. In this second embodiment, panel signals are sent from the first monitor controller, which includes the TCON, to the decoder driver of the first panel driver unit.

The first monitor controller 132 can also send power and control signals to a backlight inverter (not shown) for powering a backlight (not shown) in the first monitor 108. In addition, the first monitor controller 132 can also send power signals to the first screen 112.

Similarly, a second monitor controller 140 of the multi-screen graphics apparatus 104 sends panel signals to a second panel driver unit 142 of the second monitor 110. In one embodiment, the second panel driver unit 142 includes a TCON 144 and a driver decoder 146 connected thereto. The panel signals are sent from the second monitor controller 140 to the TCON 144 of the second panel driver unit 142 using panel signals. In a second embodiment (not shown), a second panel driver unit includes a decoder driver, but a TCON is relocated to a second monitor controller. In this second embodiment, panel signals are sent from the second monitor controller to the decoder driver of the second panel driver unit.

The second monitor controller 140 can also send power and control signals to a backlight inverter (not shown) for powering a backlight (not shown) in the second monitor 110. In addition, the first monitor controller 140 can also send power signals to the second screen 114.

The multi-screen graphics apparatus 104 includes a housing 148 containing the first monitor controller 132 with a first frame store device 150, and the second monitor controller 140 with a second frame store device 152. The first monitor controller 132 controls images displayed on the first screen 112, and the second monitor controller 140 controls images displayed on the second screen 114. The multi-screen graphics apparatus 104 also includes a display identification module 154 and a replicator 156.

The display identification module 154 includes software and/or hardware for storing display identification data that is sent to the graphics card 118. The display identification data defines the resolution to be generated by the graphics card 118. The display identification module 154 can include a memory device 158, such as a programmable read-only memory (PROM) device or an electrically erasable programmable read-only memory (EEPROM) device, for storing extended display identification data (EDID). In the embodiment shown in FIG. 4, the display identification module 154 resides in the first monitor controller 132. In other embodiments, the display identification module 154 can reside in the second monitor controller 140, in the replicator 156, elsewhere in the housing 148, or in the computer 102.

Consistent with the principles of the present invention, the display identification data sent to the graphics card 118 causes the card 118 to produce a video controller signal corresponding to an effective resolution that is greater than either of the first native resolution or the second native resolution.

In an exemplary embodiment, the first native resolution and the second native resolution are equal, and the effective resolution is twice that of the first (or second) native resolution. In this exemplary embodiment, the display identification module 154 includes identification data sent to the graphics card 118 that causes the graphics card 118 to output an effective resolution that is twice the first native resolution of the first screen 112, or the second native resolution of the second screen 114.

The replicator 156 receives the video controller signal and replicates at least a portion thereof to produce a first set of video data for the first monitor controller 132 and a second set of video data for the second monitor controller 140. In the exemplary embodiment described above, the first set of video data is substantially equal to the second set of video data, which is to say that the replicator 156 copies the video signal to produce two substantially identical sets of video data. The first monitor controller 132 processes the first set of video data to produce a first image on the first screen 112, and the second monitor controller 140 processes the second set of video data to produce a second image on the second screen 114.

In particular, the first monitor controller 132 receives the first set of video data from the replicator 156. If the first set of video data is not already in digital form, the first set of video data is converted into a digital representation, and then stored in the first frame store device 150 of the first monitor controller 132. Likewise, the second monitor controller 140 receives the second set of video data. If the second set of video data is not already in digital form, the second set of video data is converted into a digital representation, and then stored in the second frame store device 152 of the second monitor controller 140. The first monitor controller 132 is programmed, using firmware instructions, to only use a portion of the digital representation of first set of video data stored in the first frame store device 150 to produce an image on the first screen 112. Likewise, the second monitor controller 140 is programmed, using firmware instructions, to only use a portion of the digital representation of the second set of video data in the second store frame device 152 to produce an image on the second screen 114.

Consider, for example, the exemplary embodiment in which the first set of video data and the second set of video data are substantially equal, and suppose that each monitor 108 and 110 has a native resolution of 1280×1024 pixels (i.e., R₁=R₂=128)×1024 pixels). According to the principles of the present invention, the display identification module 154 sends EDID that specifics a resolution of 2560×1024 pixels, in effect “fooling” the graphics card 118 into outputting a resolution normally applicable to a single monitor having a resolution of 2560×1024. Accordingly, a video signal corresponding to this 2560×1024 resolution is sent from the graphics card 118 to the replicator 156, where it is copied to produce two sets of video data, each corresponding to the 2560×1024 resolution. A first set of video data is sent from the replicator 156 to the first monitor controller 132, and a second set, which in this exemplary embodiment is substantially identical to the first set, is sent from the replicator 156 to the second monitor controller 140. The first set of video data is written into the first frame store device 150 of the first monitor controller 132, whereas the second set of video data is written into the second frame store device 152 of the second monitor controller 140. The first monitor controller 132 outputs video information corresponding to a resolution of 1280×1024 pixels. Likewise, the second monitor controller 140 outputs video information corresponding to a resolution of 1280×1024 pixels. To ensure that the video information corresponds to these resolutions, the output video resolution of each of the controllers 132 and 140 is set in firmware to 1280×1024 pixels. Depending on whether the first screen 112 is the right or left screen, in one embodiment, the start point for reading data from the respective frame store device is either memory location 0 or 1280. In this way, the first monitor controller 132 uses half of the pixel information to create an image on the first screen 112, and the second monitor controller 140 uses the other half to create an image on the second screen 114.

Conventional monitors have monitor controllers residing therein. In the computer system 100 shown in FIGS. 2-4, however, the first monitor controller 132 and the second monitor controller 140 reside in the housing, which is disposed outside of the monitors 108 and 110. Advantageously, because the controllers 132 and 140 reside outside of the monitors 108 and 110, the monitors 108 and 110 are lighter, slimmer, and cheaper to manufacture.

It should be understood that in some embodiments, at least one of the monitor controllers 132 and 140, the display identification module 154 and the replicator 156 can be disposed in at least one of the base 120, the arm 122 and the column 124, instead of in the housing 148 outside such structures.

### EXAMPLE 2

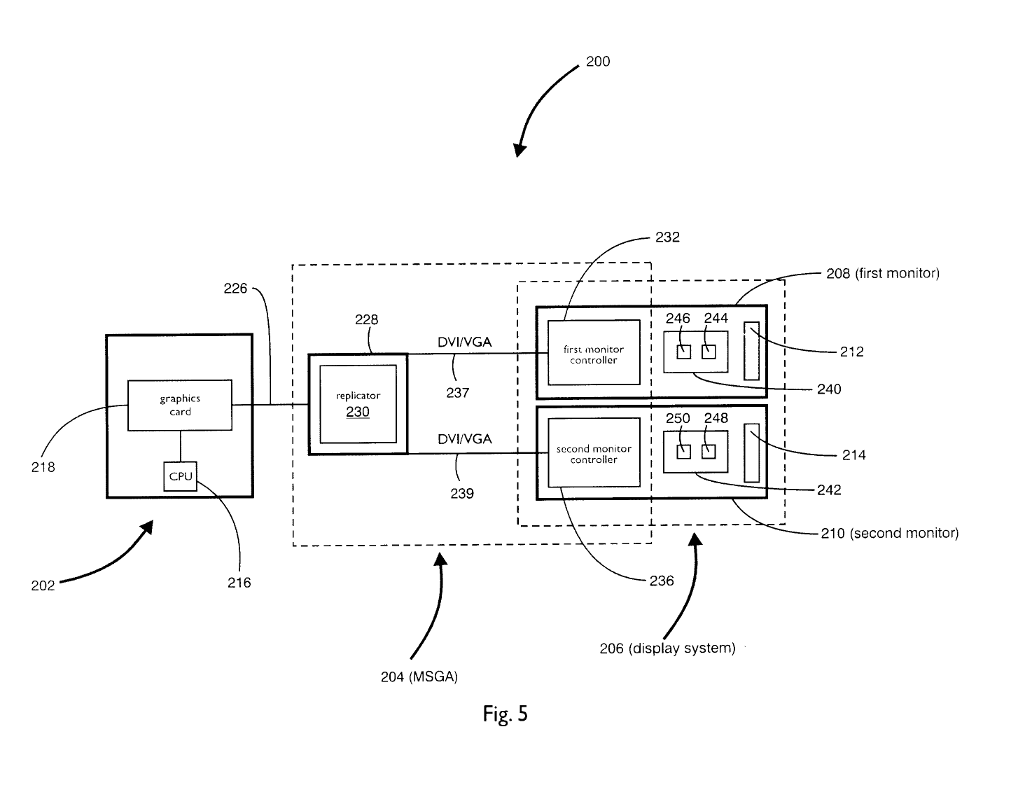

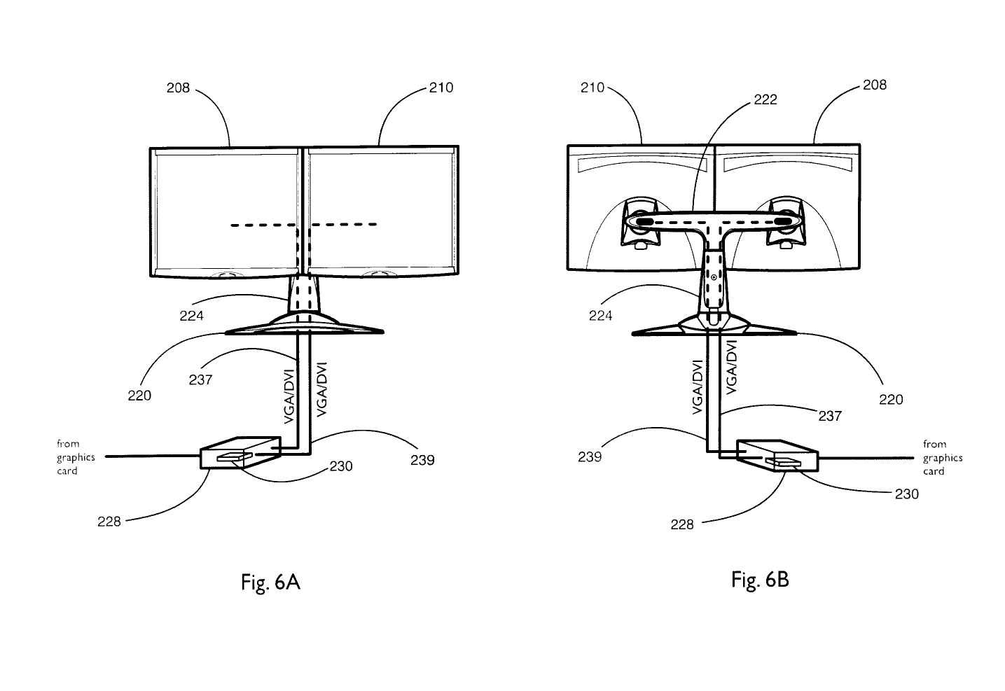

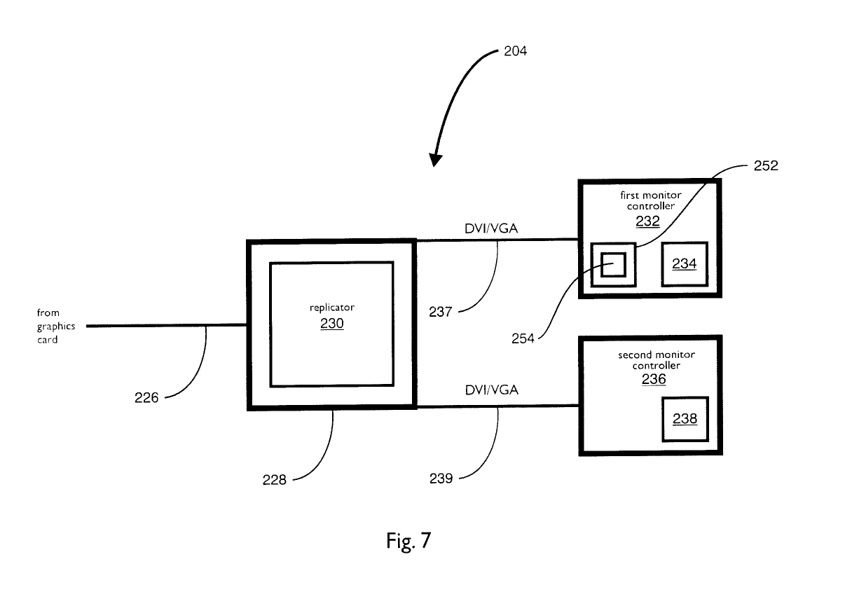

Reference is now made to FIGS. 5, 6A, 6B and 7. FIG. 5 shows a block diagram of a computer system 200 having a computer 202, a multi-screen graphics apparatus 204, and a display system 206 having first monitor 208 and a second monitor 210, in accordance with the principles of the present invention. FIGS. 6A, 6B and 7 respectively, show the front and back of the display system 206, and a block diagram of the multi-screen graphics apparatus 204 of FIG. 5. The first monitor 208 includes a first screen 212 with a first native resolution, and the second monitor 210 includes a second screen 214 with a second native resolution. The computer 202 can include a laptop, notebook or PC having a central processing unit 216 and a graphics card 218. The display system 206 includes a base 220, an arm 222 for supporting the first monitor 208 and the second monitor 210, and a column 224 for connecting the base 220 to the arm 222. The graphics card 218 is connected to the multi-screen graphics apparatus 204 with one cable 226 carrying VGA or DVI signals, for example. As described in detail below, the multi-screen graphics apparatus 204 allows video data to be displayed in the two-screen display system 206, even if the graphics card 218 has only one graphics port.

The multi-screen graphics apparatus 204 includes a housing 228 containing a replicator 230. The multi-screen graphics apparatus 204 also includes a first monitor controller 232 with a first frame store device 234, and a second monitor controller 236 with a second frame store device 238, the first monitor controller 232 and second monitor controller 236 residing inside the first monitor 208 and second monitor 210, respectively. The replicator 230 is connected to the first monitor controller 232 via a first cable 237 and to the second monitor controller 236 via at second cable 239.

The first monitor 208 also includes a first panel driver unit 240 connected to the first monitor controller 232. The second monitor 210 also includes a second panel driver unit 242 connected to the second monitor controller 236. The first panel driver unit 240 includes at least a driver decoder 244. In one embodiment, the first panel driver unit 240 also includes a TCON 246. In this case, the first monitor controller 232 communicates with the TCON 246 by sending LVDS thereto. In a second embodiment (not shown), a TCON is relocated to a first monitor controller. In this case, the first monitor controller communicates with a decoder driver by sending RSDS thereto.

The first monitor controller 232 can also send power and control signals to a backlight inverter (not shown) for powering a backlight (not shown) in the first monitor 208. In addition, the first monitor controller 232 can also send power signals to the first screen 212.

Likewise, the second panel driver unit 242 includes at least a driver decoder 248. In one embodiment, the second panel driver unit 242 also includes a TCON 250. In this case, the second monitor controller 236 communicates with the TCON 250 by sending LVDS thereto. In a second embodiment (not shown), similar to a smart panel display, a TCON is relocated to a second monitor controller. In this case, the second monitor controller communicates with the decoder driver by sending RSDS thereto.

The second monitor controller 236 can also send power and control signals to a backlight inverter (not shown) for powering a backlight (not shown) in the second monitor 210. In addition, the second monitor controller 236 can also send power signals to the second screen 214.

The first monitor controller 232 controls images displayed on the first screen 212, and the second monitor controller 236 controls images displayed on the second screen 214. The multi-screen graphics apparatus 204 further includes a display identification module 252.

The display identification module 252 includes software and/or hardware for storing display identification data that is sent to the graphics card 218. The display identification data defines the resolution to be generated by the graphics card 218. The display identification module 252 can include a memory device 254, such as a programmable read-only memory (PROM) device or an electrically erasable programmable read-only memory (EEPROM) device, for storing extended display identification data (EDID). In the embodiment shown in FIG. 7, the display identification module resides in the first monitor controller 232. In other embodiments, the display identification module can reside in the second monitor controller 236, in the replicator 230, elsewhere in the housing 228, or in the computer 202.

In an exemplary embodiment, the first native resolution and the second native resolution are equal, and the effective resolution is twice that of the first (or second) native resolution. In this exemplary embodiment, the display identification module 252 includes identification data sent to the graphics card 218 that causes the graphics card 218 to output an effective resolution that is twice the first native resolution of the first screen 212, or the second native resolution of the second screen 214.

The replicator 230 receives the video controller signal and replicates at least a portion thereof to produce a first set of video data for the first monitor controller 232 and a second set of video data for the second monitor controller 236. The first set of video data is sent to the first monitor controller 232 and the second set of video data is sent to the second monitor controller 236 in the form of controller signals, such as VGA or DVI, via the first cable 237 and second cable 239 respectively. In the exemplary embodiment described above, the first set of video data is equal to the second set of video data, i.e., the replicator 230 copies the video signal to produce two identical sets of video data. The first monitor controller 232 processes the first set of video data to produce a first image on the first screen 212, and the second monitor controller 236 processes the second set of video data to produce a second image on the second screen 214.

In particular, the first monitor controller 232 receives the first set of video data from the replicator 230. If the first set of video data is not already in digital form, the first set of video data is converted into a digital representation, and then stored in the first frame store device 234 of the first monitor controller 232. Likewise, the second monitor controller 230 receives the second set of video data. If the second set of video data is not already in digital form, the second set of video data is converted into a digital representation, and then stored in the second frame store device 238 of the second monitor controller 236. The first monitor controller 232 is programmed, using firmware instructions, to only use a portion of the digital representation of first set of video data stored in the first frame store device 234 to produce an image on the first screen 212. Likewise, the second monitor controller 236 is programmed, using firmware instructions, to only use a portion of the digital representation of the second set of video data in the second frame store device 238 to produce an image on the second screen 214.

Consider, for example, the exemplary embodiment in which the first set of video data and the second set of video data are substantially equal, and suppose that each of the monitors 208 and 210 has a native resolution of 1280×1024 pixels (i.e., R₁=R₂=1280×1024 pixels). According to the principles of the present invention, the display identification module 252 sends EDID that specifies a resolution of 2560×1024 pixels, in effect “fooling” the graphics card 218 into outputting a resolution normally applicable to a single monitor having a resolution of 2560×1024. Accordingly, a video signal corresponding to this 2560×1024 resolution is sent from the graphics card 218 to the replicator 230, where it is copied to produce two sets of video data, each corresponding to the 2560×1024 resolution. A first set of video data is sent from the replicator 230 to the first monitor controller 232, and a second set, which in this exemplary embodiment is substantially identical to the first set, is sent from the replicator 230 to the second monitor controller 236. The first set of video data is written into the first frame store device 234 of the first monitor controller 232, whereas the second set of video data is written into the second frame store device 238 of the second monitor controller 236. The first monitor controller 232 outputs video information corresponding to a resolution of 1280×1024 pixels. Likewise, the second monitor controller 236 outputs video information corresponding to a resolution of 1280×1024 pixels. To ensure that the video information corresponds to these resolutions, the output video resolution of each of the controllers 232 and 236 is set in firmware to 1280×1024 pixels. Depending on whether the first screen 212 is the right or left display, in one embodiment, the starting point for reading data from the respective frame store device is either memory location 0 or 1280. In this way, the first monitor controller 232 uses half of the pixel information to create an image on the first screen 212, and the second monitor controller 236 uses the other half to create an image on the second screen 214.

In the embodiment shown in FIGS. 5-7, the first monitor controller 232 and the second monitor controller 236 reside in the first and second monitors 208 and 210, respectively. Advantageously, by using the monitor controllers in the monitors, the housing 228 and its contents are lighter, slimmer and cheaper to manufacture.

It should be understood that in some embodiments, at least one of the display identification module 252 and the replicator 230 can be disposed in at least one of the base 220, the arm 222 and the column 224.

### EXAMPLE 3

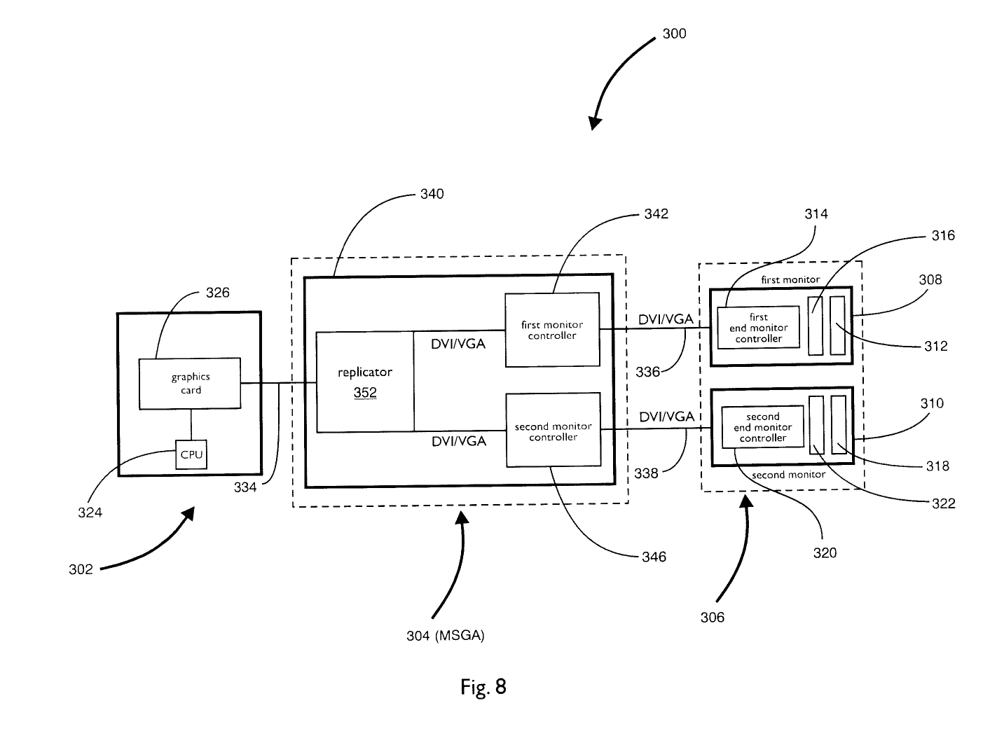

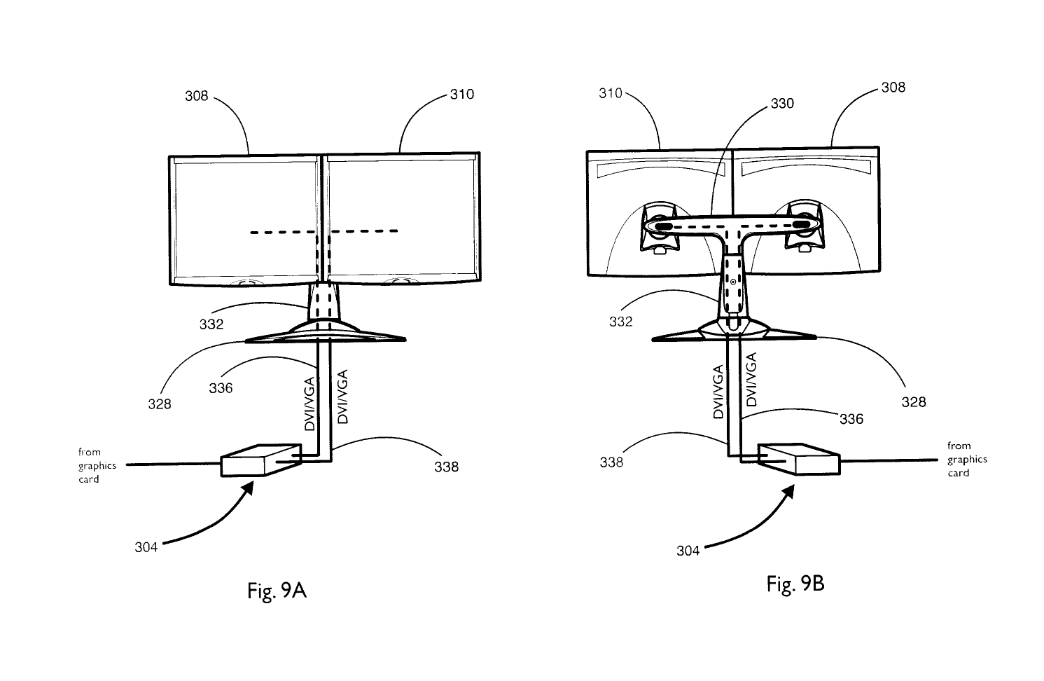

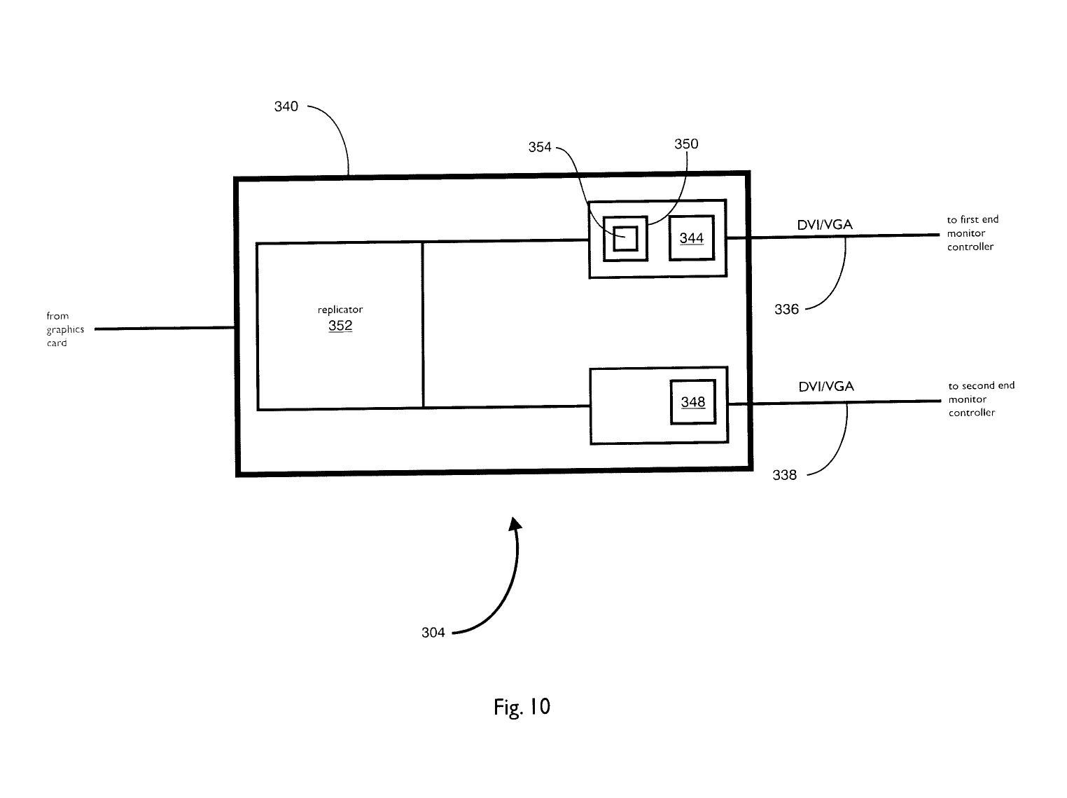

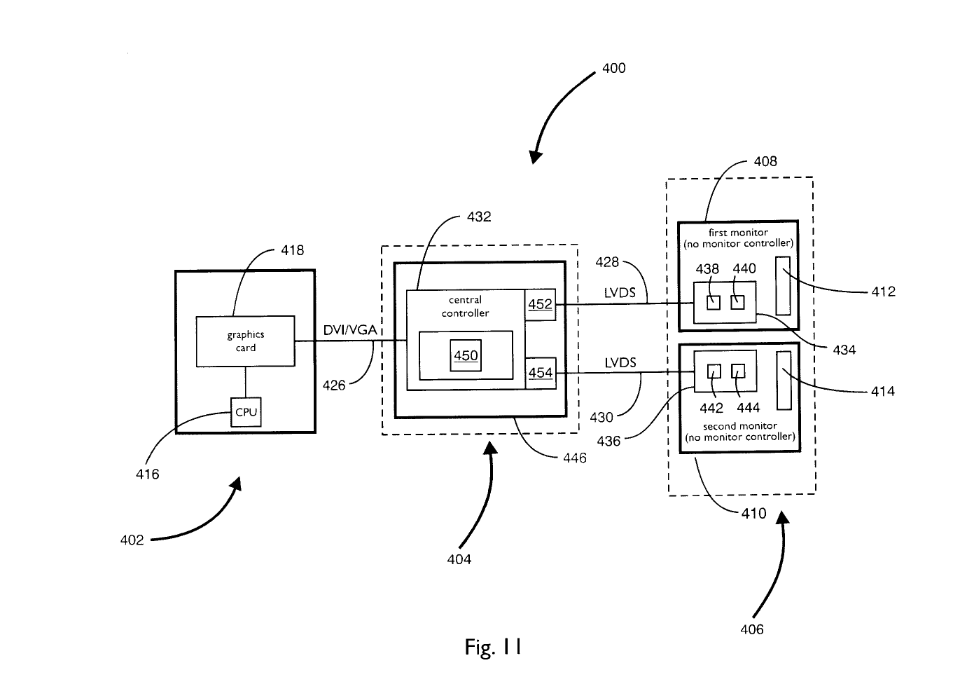

Reference is now made to FIGS. 8, 9A, 9B and 10. FIG. 8 shows a block diagram of a computer system 300 having a computer 302, a multi-screen graphics apparatus 304, and a display system 306 having a first monitor 308 and a second monitor 310, in accordance with the principles of the present invention. FIGS. 9A, 9B and 10 respectively show the front and back of the display system 306, and a block diagram of the multi-screen graphics apparatus 304 of FIG. 8. The first monitor 308 includes a first screen 312 with a first native resolution. The first monitor 308 also includes a first end monitor controller 314 and a first panel driver unit 316. The second monitor 310 includes a second screen 318 with a second native resolution. The second monitor 310 also includes a second end monitor controller 320 and a second panel driver unit 322. The designation “end” is used in this example to distinguish the first and second monitor controllers 314 and 320 in the monitors from the first and second monitor controllers in the multi-screen graphics apparatus 304, described below. The computer 302 can include a laptop, notebook or PC having a central processing unit 324 and a graphics card 326. The display system 306 includes a base 328, an arm 330 for supporting the first monitor 308 and the second monitor 310, and a column 332 for connecting the base 328 to the arm 330. As described in detail below, the multi-screen graphics apparatus 304 allows video data to be displayed in the two-screen display system 306, even if the graphics card 326 has only one graphics port. The graphics card 326 is connected to the multi-screen graphics apparatus 304 with one cable 334 carrying VGA or DVI signals, for example. The multi-screen graphics apparatus 304 is connected to the first monitor 308 and to the second monitor 310 with a first cable 336 and a second cable 338, respectively, carrying controller signals, such as VGA or DVI signals.

The multi-screen graphics apparatus 304 includes a housing 340 containing a first monitor controller 342 with a first frame store device 344, and a second monitor controller 346 with a second frame store device 348. The multi-screen graphics apparatus 304 also includes a display identification module 350 and a replicator 352. The first monitor controller 342 controls images displayed on the first screen 312, and the second monitor controller 346 controls images displayed on the second screen 318.

The first end monitor controller 314 and/or the first monitor controller 342 can also send power and control signals to a backlight inverter (not shown) for powering a backlight (not shown) in the first monitor 308. In addition, the first end monitor controller 314 and/or the first monitor controller 342 can also send power signals to the first screen 312. Likewise, the second end monitor controller 320 and/or the second monitor controller 346 can also send power and control signals to a backlight inverter (not shown) for powering a backlight (not shown) in the second monitor 310. In addition, the second end monitor controller 320 and/or the second monitor controller 346 can also send power signals to the second screen 318.

The display identification module 350 includes software and/or hardware for storing display identification data that is sent to the graphics card 326. The display identification data defines the resolution to be generated by the graphics card 326. The display identification module 350 can include a memory device 354, such as a programmable read-only memory (PROM) device or an electrically erasable programmable read-only memory (EEPROM) device, for storing extended display identification data (EDID). In the embodiment shown in FIG. 10, the display identification module 350 resides in the first monitor controller 342. In other embodiments, the display identification module can reside in the second monitor controller 346, in the replicator 352, elsewhere in the housing, in one of the end monitor controllers 314 or 320, or in the computer 302.

Consistent with the principles of the present invention, the display identification data sent to the graphics card 326 causes the card 326 to produce a video controller signal corresponding to an effective resolution that is greater than either of the first native resolution or the second native resolution.

In an exemplary embodiment, the first native resolution and the second native resolution are equal, and the effective resolution is twice that of the first (or second) native resolution. In this exemplary embodiment, the display identification module 350 includes identification data sent to the graphics card 326 that causes the graphics card 326 to output an effective resolution that is twice the first native resolution of the first screen 312, or the second native resolution of the second screen 318.

The replicator 352 receives the video controller signal and replicates at least a portion thereof to produce a first set of video data for the first monitor controller 342 and a second set of video data for the second monitor controller 346. In the exemplary embodiment described above, the first set of video data is substantially equal to the second set of video data, i.e., the replicator 352 copies the video signal to produce two substantially identical sets of video data. The first monitor controller 342 processes the first set of video data to produce a first image on the first screen 312, and the second monitor controller 346 processes the second set of video data to produce a second image on the second screen 318.

In particular, the first monitor controller 342 receives the first set of video data from the replicator 352. If the first set of video data is not already in digital form, the first set of video data is converted into a digital representation, and then stored in the first frame store device 344 of the first monitor controller 342. Likewise, the second monitor controller 346 receives the second set of video data. If the second set of video data is not already in digital form, the second set of video data is converted into a digital representation, and then stored in the second frame store device 348 of the second monitor controller 346. The first monitor controller 342 is programmed, using firmware instructions, to only use a portion of the digital representation of first set of video data stored in the first frame store device 344 to produce an image on the first screen 312. Likewise, the second monitor controller 346 is programmed, using firmware instructions, to only use a portion of the digital representation of the second set of video data in the second frame store device 348 to produce an image on the second screen 318.

Consider, for example, the exemplary embodiment in which the first set of video data and the second set of video data are substantially equal, and suppose that each of the monitors 308 and 310 has a native resolution of 1280×1024 pixels (i.e., R₁=R₂=1280×1024 pixels). According to the principles of the present invention, the display identification module 350 sends EDID that specifics a resolution of 2560×1024 pixels, in effect “fooling” the graphics card 326 into outputting a resolution normally applicable to a single monitor having a resolution of 2560×1024. Accordingly, a video controller signal corresponding to this 2560×1024 resolution is sent from the graphics card 326 to the replicator 352, where it is copied to produce two sets of video data, each corresponding to the 2560×1024 resolution. A first set of video data is sent from the replicator 352 to the first monitor controller 342, and a second set, which in this exemplary embodiment is substantially identical to the first set, is sent from the replicator 352 to the second monitor controller 346. The first set of video data is written into the first frame store device 344 of the first monitor controller 342, whereas the second set of video data is written into the second frame store device 348 of the second monitor controller 346. The first monitor controller 342 outputs video information corresponding to a resolution of 1280×1024 pixels. Likewise, the second monitor controller 346 outputs video information corresponding to a resolution of 1280×1024 pixels. To ensure that the video information corresponds to these resolutions, the output video resolution of each of the controllers 342 and 346 is set in firmware to 1280×1024 pixels. Depending on whether the first display is the right or left display, in one embodiment, the starting point for reading data from the respective frame store device 344 and 348 is either memory location 0 or 1280. In this way, the first monitor controller 342 uses half of the pixel information to create an image on the first screen 312, and the second monitor controller 346 uses the other half to create an image on the second screen 318.

The first monitor controller 342 in the multi-screen graphics apparatus 304 is connected to the first end monitor controller 314 via the first cable 336. The second monitor controller 346 in the multi-screen graphics apparatus 304 is connected to the second end monitor controller 320 via the second cable 338. The first monitor controller 342 of the multi-screen graphics apparatus 304 sends the processed first set of video data to the first end monitor controller 314. The processed first set of video data can include controller signals, such as DVI or VGA signals. Likewise, the second monitor controller 346 of the multi-screen graphics apparatus 304 sends the processed second set of video data to the second end monitor controller 320. The processed second set of video data can include controller signals, such as DVI or VGA signals. The first and second end monitor controllers 314 and 320 process these controller signals to produce respective images on the first and second screens 312 and 318.

Advantageously, the embodiment shown in FIGS. 8-10 can be used with conventional monitors having conventional monitor controllers, which were referred to as end monitor controllers in the foregoing. The first monitor controller 342 and the second monitor controller 346 of the multi-screen graphics apparatus 304 can output controller signals, such as VGA or DVI signals, which are transmitted to the first end monitor controller 314 and the second end monitor controller 320 or the monitors 308 and 310, respectively, which then processes the signals to produce an image on the screens.

### EXAMPLE 4

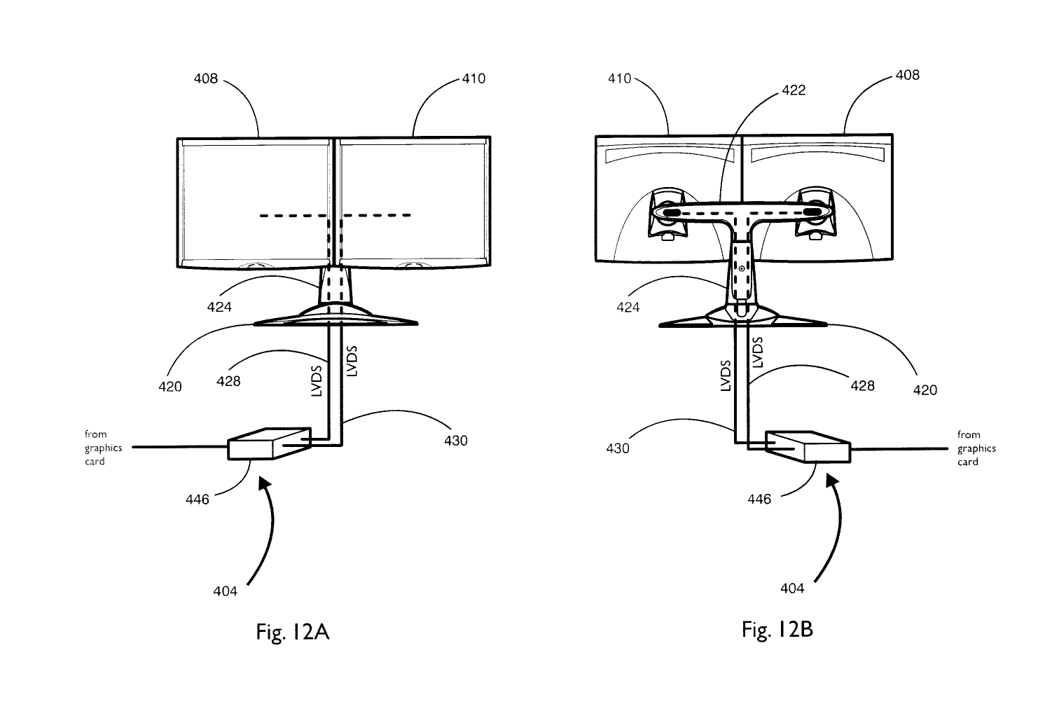

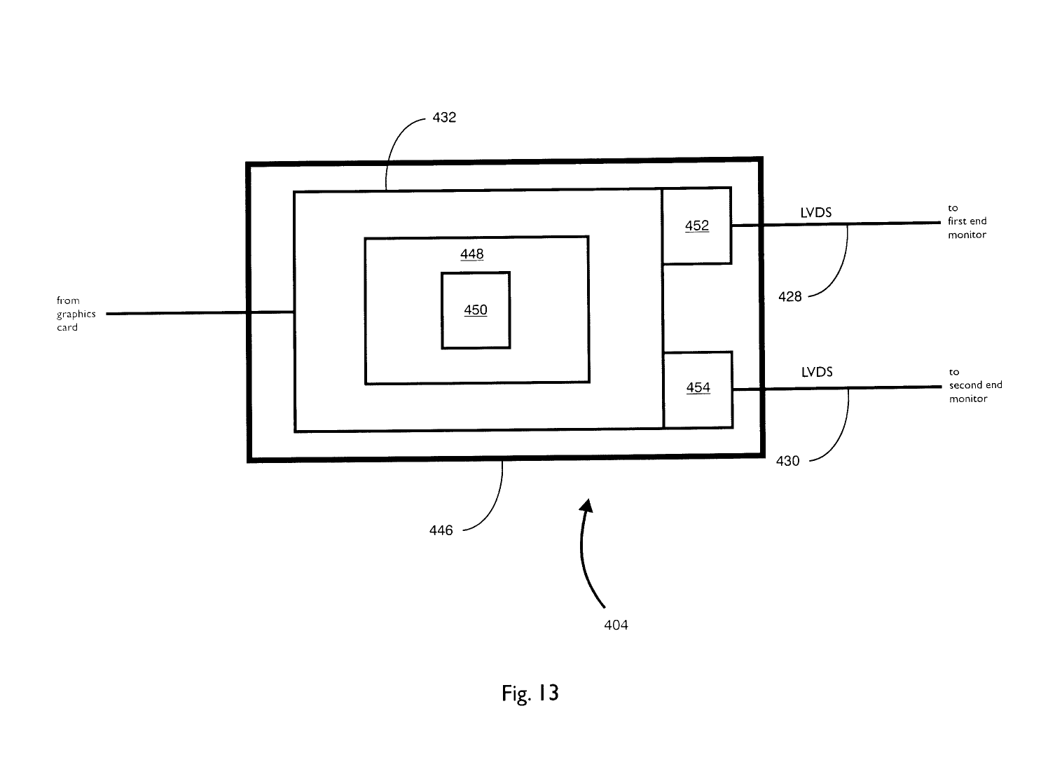

Reference is now made to FIGS. 11, 12A, 12B and 13. FIG. 11 shows a block diagram of a computer system 400 having a computer 402, a multi-screen graphics apparatus 404, and a display system 406 having a first monitor 408 and a second monitor 410, in accordance with the principles of the present invention. FIGS. 12A, 12B and 13 respectively show the front and back of the display system 406 and a block diagram of the multi-screen graphics apparatus 404 of FIG. 11. The first monitor 408 includes a first screen 412 with a first native resolution, and the second monitor 410 includes a second screen 414 with a second native resolution. The computer 402 can include a laptop, notebook or PC having a central processing unit 416 and a graphics card 418. The display system includes a base 420, an arm 422 for supporting the first monitor and the second monitor, and a column 424 for connecting the base 420 to the arm 422. As described in detail below, the multi-screen graphics apparatus 404 allows video data to be displayed in the two-screen display system 406, even if the graphics card 418 has only one graphics port. The graphics card 418 is connected to the multi-screen graphics apparatus 404 with one cable 426 carrying controller signals, such as VGA or DVI signals, for example. The multi-screen graphics apparatus 404 is connected to the first monitor 408 and to the second monitor 410 with a first cable 428 and a second cable 430, respectively, carrying panel signals, such as LVDS.

In particular, a central controller 432 of the multi-screen graphics apparatus 404 sends panel signals to a first panel driver unit 434 of the first monitor 408 and to a second panel driver unit 436 of the second monitor 410. In one embodiment, the first panel driver unit 434 includes a TCON 438 and a driver decoder 440 connected thereto. The panel signals are sent from the central controller 432 to the TCON 438 of the first panel driver unit 434 using panel signals. In a second embodiment, similar to smart panel systems, the first panel driver unit includes a decoder driver, but the TCON is relocated to the central controller. In this second embodiment, panel signals are sent from the central controller, which includes a TCON, to the driver decoder or the first panel driver unit.

Similarly, the central controller 432 of the multi-screen graphics apparatus 404 sends panel signals to the second panel driver unit 436 of the second monitor 410. In one embodiment, the second panel driver unit 436 includes a TCON 442 and a driver decoder 444 connected thereto. The panel signals are sent from the central controller 432 to the TCON 442 of the second panel driver unit 436 using panel signals. In a second embodiment, the second panel driver unit 436 includes a driver decoder, but the TCON is relocated to the central controller. In this second embodiment, panel signals are sent from the central controller to the driver decoder of the second panel driver unit.

The central controller 432 can also send power and control signals to a backlight inverter (not shown) for powering a backlight (not shown) in the first monitor 408. In addition, the central controller 432 can also send power signals to the first screen 412.

The apparatus 404 includes a housing 446 containing a display identification module 448 and the central controller 432. The display identification module 448 includes software and/or hardware for storing display identification data that is sent to the graphics card 418. The display identification data defines the resolution to be generated by the graphics card 418. The display identification module 448 can include a memory device 450, such as a programmable read-only memory (PROM) device or an electrically erasable programmable read-only memory (EEPROM) device, for storing extended display identification data (EDID). In the embodiment shown in FIG. 13, the display identification module 448 resides in the central processor 432. In other embodiments, the display identification module 448 can reside elsewhere in the housing 446, or in the computer 402.

Consistent with the principles of the present invention, the display identification data sent to the graphics card 418 causes the card 418 to produce a video controller signal corresponding to an effective resolution that is greater than either of the first native resolution or the second native resolution.

In an exemplary embodiment, the first native resolution and the second native resolution are equal, and the effective resolution is twice that of the first (or second) native resolution. In this exemplary embodiment, the display identification module 448 includes identification data sent to the graphics card 418 that causes the graphics card 418 to output an effective resolution that is twice the first native resolution of the first screen 412, or the second native resolution of the second screen 414.

The central controller 432 divides at least a portion of the video controller signal into a first video stream and a second video stream. The first video stream is sent to the first monitor 408 for producing an image on the first screen. Likewise, the second video stream is sent to the second monitor 410 for producing an image on the second screen 414. The central controller 432 has a first output port 452 connected to the first monitor 408 via the first cable 428, and a second output port 454 connected to the second monitor 410 via the second cable 430. The first cable 428 and the second cable 430 carry panel signals, such as LVDS signals, to the first monitor 408 and the second monitor 410, respectively.

Consider, for example, the exemplary embodiment, in which R₁=R₂, and suppose further that R₁=R₂=1280×1024 pixels. In this exemplary embodiment, display identification data is sent to the graphics card 418 that specifies a resolution of 2560×1024 pixels, in effect “fooling” the graphics card 418 into outputting a resolution normally applicable to a single monitor having a resolution of 2560×1024 pixels. Accordingly, a video signal corresponding to this 2560×1024 resolution is sent from the graphics card 418 to the central controller 432. Such a video signal can be a controller signal, such as VGA or DVI. The central controller 432 divides the video signal into two streams, each stream corresponding to a resolution of 1280×1024 pixels. These two streams are in the form of panel signals, such as LVDS. One stream is sent to the first panel driver unit 434 in the first monitor 408 via the first cable 428, and a different second stream is sent to a second panel driver unit 436 in the second monitor 410 via the second cable 430, for producing images on the respective screens 412 and 414. Thus, video information required to produce a first image is sent to the first monitor 408, whereas different video information required to produce a second image is sent to the second monitor 410. In this exemplary embodiment, half the pixel information of the 2560×1024 resolution video signal is sent to the first monitor 408, whereas the other half is sent to the second monitor 410.

There are several advantages to using the central controller 432 shown in FIGS. 11 and 13. First, only one central controller 432 is used, instead of a plurality of controllers. Second, the central controller 432 obviates the need for monitor controllers to reside in the monitors, resulting in monitors that are lighter, slimmer, and cheaper to manufacture.

It should be understood that in some embodiments, at least one of the central controller 432 and the display identification module 448 can be disposed in at least one of the base 420, the arm 422 and the column 424, instead of in the housing 446 outside such structures.

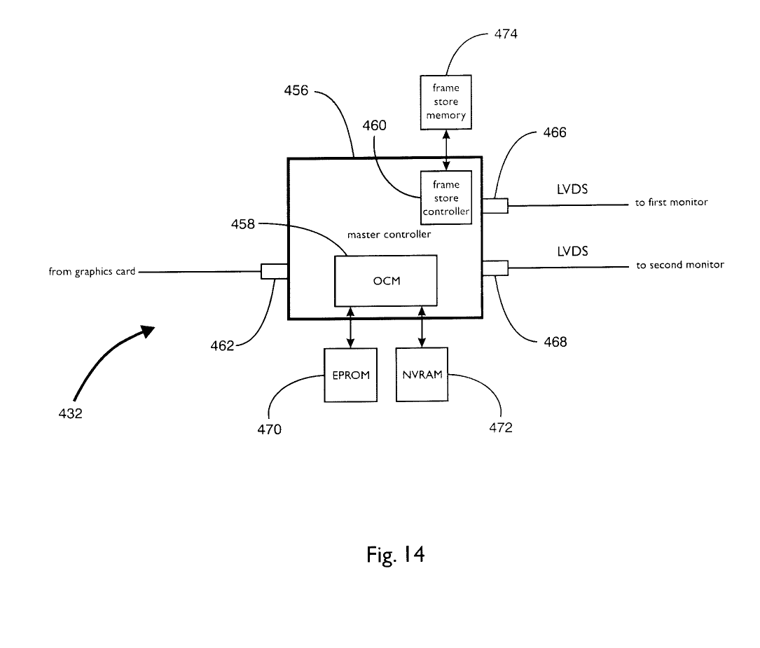

FIG. 14 shows one embodiment of the central controller 432 of FIGS. 11 and 13. The central controller 432 includes a master controller 456 having an on-chip-microcontroller (OCM) 458, a frame store controller 460, an input port 462 and two output ports 466,468. The central controller 432 also includes a serial EPROM 470, a non-volatile random access memory (NVRAM) 472 and a frame store memory 474, all of which communicate with the master controller 456. In particular, the frame store controller 460 communicates with the frame store memory 474, and the OCM 458 communicates with the EPROM 470 and the NVRAM 472.

In operation, a controller signal, such as a VGA or DVI signal, arrives from the graphics card (not shown in FIG. 14) at the input port 462. In another embodiment (not shown), a second input port is present, so that one port can accept VGA signals and the other port can accept DVT signals, resulting in a central controller that is compatible with more types of graphics cards.

A digital representation of the controller signals is stored in the frame store memory 474. The frame store controller 460 extracts and processes a portion of the stored digital representation. The master controller 456 outputs panel signals, such as LVDS, via the first output port 466 destined for the TCON 438 of the first panel driver unit 434 to produce images on the display screen 412. Similarly, the master controller 456 outputs panel signals, such as LVDS, via the second output port 468 destined for the TCON 442 of the second panel driver unit 436 to produce images on the display screen 414.

The OCM 458 executes a firmware program running from the EPROM 470. The NVRAM 472 stores user settings, such as brightness and/or contrast settings.

### EXAMPLE 5

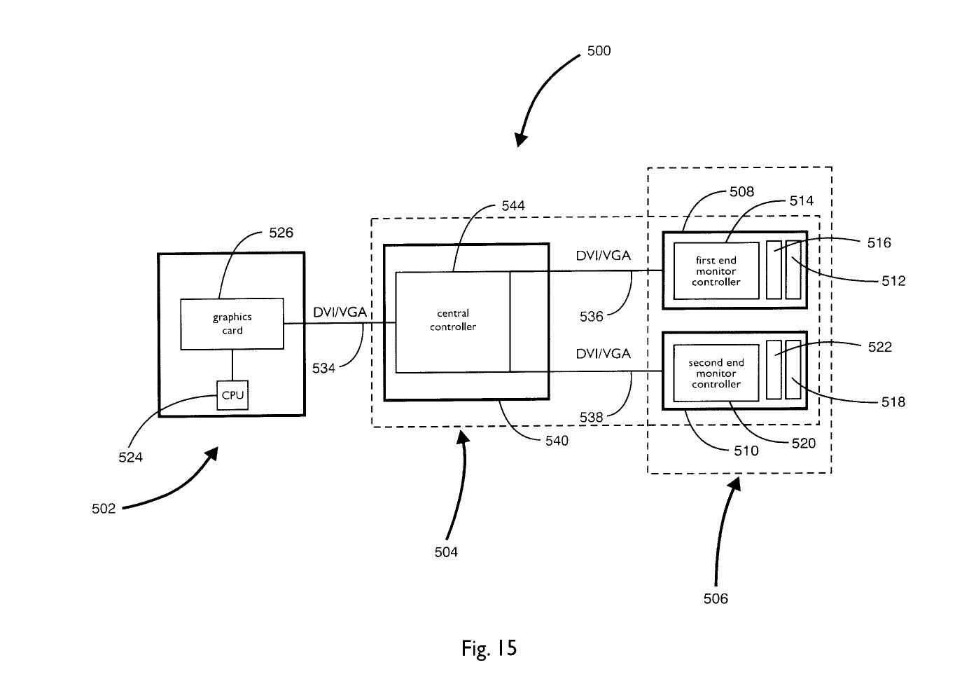

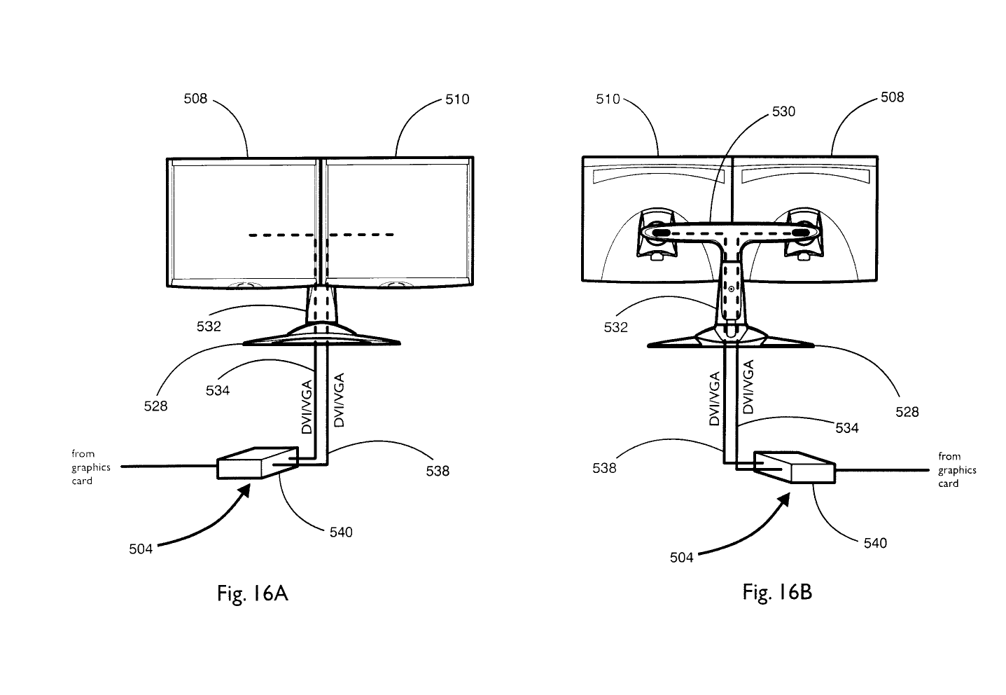

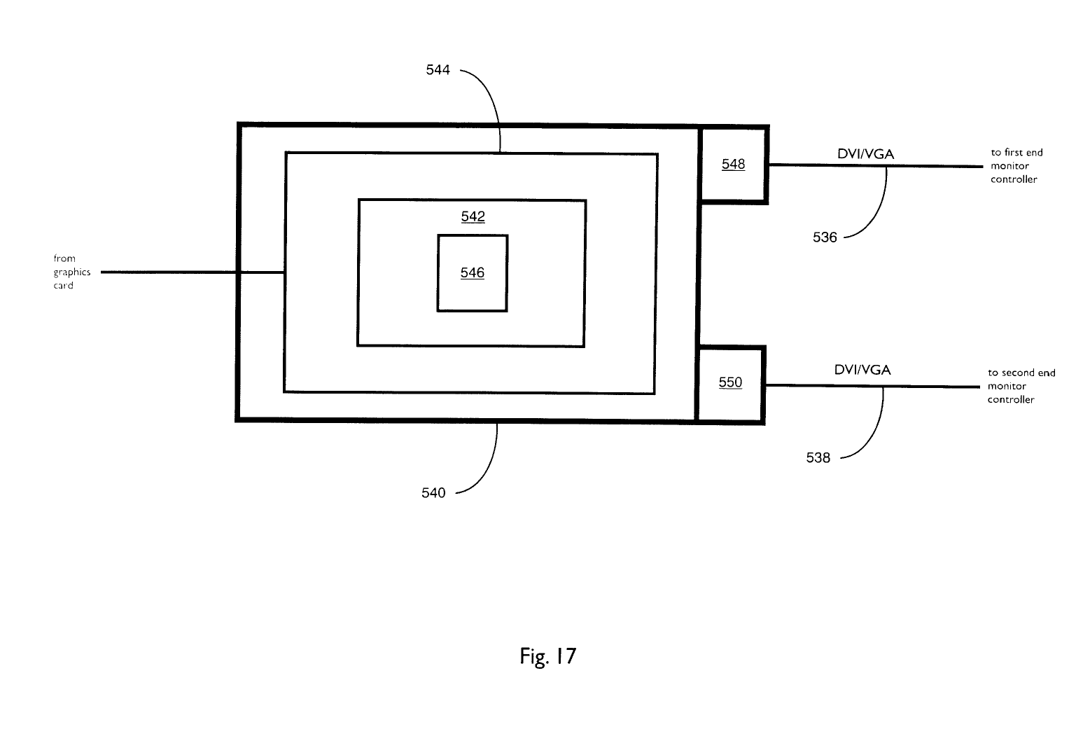

Reference is now made to FIGS. 15-17. FIG. 15 shows a block diagram of a computer system 500 having a computer 502, a multi-screen graphics apparatus 504, and a display system 506 having a first monitor 508 and a second monitor 510, in accordance with the principles of the present invention. FIGS. 16 and 17 respectively show the display system 506 and a block diagram of the multi-screen graphics apparatus 504 of FIG. 15. The first monitor 508 includes a first screen 512 with a first native resolution. The first monitor 508 also includes a first end monitor controller 514 and a first panel driver unit 516. The second monitor 510 includes a second screen 518 with a second native resolution. The second monitor 510 also includes a second end monitor controller 520 and a second panel driver unit 522. The computer 502 can include a laptop, notebook or PC having a central processing unit 524 and a graphics card 526. The display system 506 includes a base 528, an arm 530 for supporting the first monitor 508 and the second monitor 510, and a column 532 for connecting the base 528 to the arm 530. As described in detail below, the multi-screen graphics apparatus 504 allows video data to be displayed in the two-screen display system 506, even if the graphics card 526 has only one graphics port. The graphics card 526 is connected to the multi-screen graphics apparatus 504 with one cable 534 carrying controller signals, such as VGA or DVI signals. The multi-screen graphics apparatus 504 is connected to the first monitor 508 and to the second monitor 510 with a first cable 536 and a second cable 538, respectively, carrying controller signals, such as VGA or DVI signals.

The apparatus 504 includes a housing 540 containing a display identification module 542 and a central controller 544. The display identification module 542 includes software and/or hardware for storing display identification data that is sent to the graphics card 526. The display identification data defines the resolution to be generated by the graphics card 526. The display identification module 542 can include a memory device 546, such as a programmable read-only memory (PROM) device or an electrically erasable programmable read-only memory (EEPROM) device, for storing extended display identification data (EDID). In the embodiment shown in FIG. 17, the display identification module 542 resides in the central controller 544. In other embodiments, the display identification module 542 can reside elsewhere in the housing 540, in the first or second end monitor controllers 514, 520, or in the computer 502.

Consistent with the principles of the present invention, the display identification data sent to the graphics card 526 causes the card 526 to produce a video signal corresponding to an effective resolution that is greater than either of the first native resolution or the second native resolution.

In an exemplary embodiment, the first native resolution and the second native resolution are equal, and the effective resolution is twice that of the first (or second) native resolution. In this exemplary embodiment, the display identification module 542 includes identification data sent to the graphics card 526 that causes the graphics card 526 to output an effective resolution that is twice the first native resolution of the first screen 512, or the second native resolution of the second screen 518.

The central controller 544 divides at least a portion of the video signal into a first video stream and a second video stream. The first video stream is sent to the first monitor 508, specifically the first end monitor controller 514, for producing an image on the first screen 512. Likewise, the second video stream is sent to the second monitor 510, specifically the second end monitor controller 520, for producing an image on the second screen 518. The central controller 544 has a first output port 548 connected to the first end monitor controller 514 via the first cable 536, and a second output port 550 connected to the second end monitor controller 520 via the second cable 538. The first cable 536 and the second cable 538 carry controller signals, such as DVI, VGA or DisplayPort signals, to the first end monitor controller 514 and the second end monitor controller 520, respectively.

Consider, for example, the exemplary embodiment, in which R₁=R₂, and suppose further that R₁=R₂=1280×1024 pixels. In this exemplary embodiment, display identification data is sent to the graphics card 526 that specifies a resolution of 2560×1024 pixels, in effect “fooling” the graphics card 526 into outputting a resolution normally applicable to a single monitor having a resolution of 2560×1024 pixels. Accordingly, a video signal corresponding to this 2560×1024 resolution is sent from the graphics card 526 to the central controller 544. Such a video signal can be a controller signal, such as VGA, DVI or DisplayPort signals. The central controller 544 divides the video signal into two streams, each stream corresponding to a resolution of 1280×1024 pixels. These two streams are in the form of controller signals. One stream is sent to the first end monitor controller 514 in the first monitor 508 via the first cable 536, and a different second stream is sent to the second end monitor controller 520 in the second monitor 510 via the second cable 538, for producing images on the respective screens 512 and 518. Thus, video information required to produce a first image is sent to the first monitor 508, whereas different video information required to produce a second image is sent to the second monitor 510. In this exemplary embodiment, half the pixel information of the 2560×1024 resolution video signal is sent to the first monitor 508, whereas the other half is sent to the second monitor 510.

The central controller 544 and/or the first end monitor controller 514 can also send power and control signals to a backlight inverter (not shown) for powering a backlight (not shown) in the first monitor 508. The central controller 544 and/or the first end monitor controller 514 can also send power signals to the first screen 512. Likewise, the central controller 544 and/or the second end monitor controller 520 can also send power and control signals to a backlight inverter (not shown) for powering a backlight (not shown) in the second monitor 510. In addition, the central controller 544 and/or the second end monitor controller 520 can also send power signals to the second screen 518.

Advantageously, the embodiment shown in FIGS. 15-17 can be used with conventional monitors having conventional controllers. The central controller 544 outputs two controller signals, such as VGA, DVI or DisplayPort signals, which are transmitted to the end monitor controllers 514, 520 in the respective monitors 508, 510, which then process the signals to produce images thereon.

It should be understood that in some embodiments, at least one of the central controller 544 and the display identification module 542 can be disposed in at least one of the base 528, the arm 530 and the column 532, instead of in a housing outside such structures.

The controllers 132 and 140 of FIG. 2 output panel signals. In contrast, the controllers 342 and 346 of FIG. 8 output controller signals. In one embodiment, the hardware of controllers 132 and 140 is distinct from the hardware of controllers 342 and 346, the former two designed to output just panel signals and the later two designed to output just controller signals. The output ports of the controllers 132 and 140 may be different than the output ports of the controllers 342 and 346, for example. In a different embodiment, controllers 132, 140, 342, and 346 may have identical hardware. In this embodiment, each one of the four controllers is capable of outputting both panel signals and controller signals, depending on software instructions, and each one may have two types of output ports, one type for outputting panel signals and the other type for outputting controller signals. A variant of this embodiment, in which controllers 132, 140, 342 and 346 have the same hardware, would be to have just one type of output port in each of the four controllers, which type is capable of outputting both panel and controller signals depending on software instructions.

In examples described above, the principles of the present invention were elucidated by describing a two-screen display system. However, it should be understood that a two-screen system was described in the interest of simplifying the presentation. The principles of the present invention are equally applicable, mutatis mutandis, to an N-screen display system, where N is any integer greater than 1. The following table specifies the resolutions demanded by the display identification module of the graphics card in an exemplary embodiment in which the sum of the native resolutions of the screens is equal to the resolution output by the graphics card. Thus, in this exemplary embodiment, the display identification module sends EDID to the graphics card that causes the graphics card to output controller signals corresponding to a resolution of 3840×1024 for a display system having three screens in a horizontal geometry, each screen having a native resolution of 1280×1024. And, in this exemplary embodiment, the display identification module sends EDID to the graphics card that causes the graphics card to output controller signals corresponding to a resolution of 2560×2048 for a display system having four screens in a two-screens-above-two-screens geometry, each screen having a native resolution of 1280×1024.

| Display System | Graphics Card Output | Individual Display |
|---|---|---|
| Configuration | Resolution | Resolution |
| Dual horizontal | 2560 × 1024 | 2@1280 × 1024 |
| Triple horizontal | 3840 × 1024 | 3@1280 × 1024 |
| Quad 2 × 2 | 2560 × 2048 | 4@1280 × 1024 |

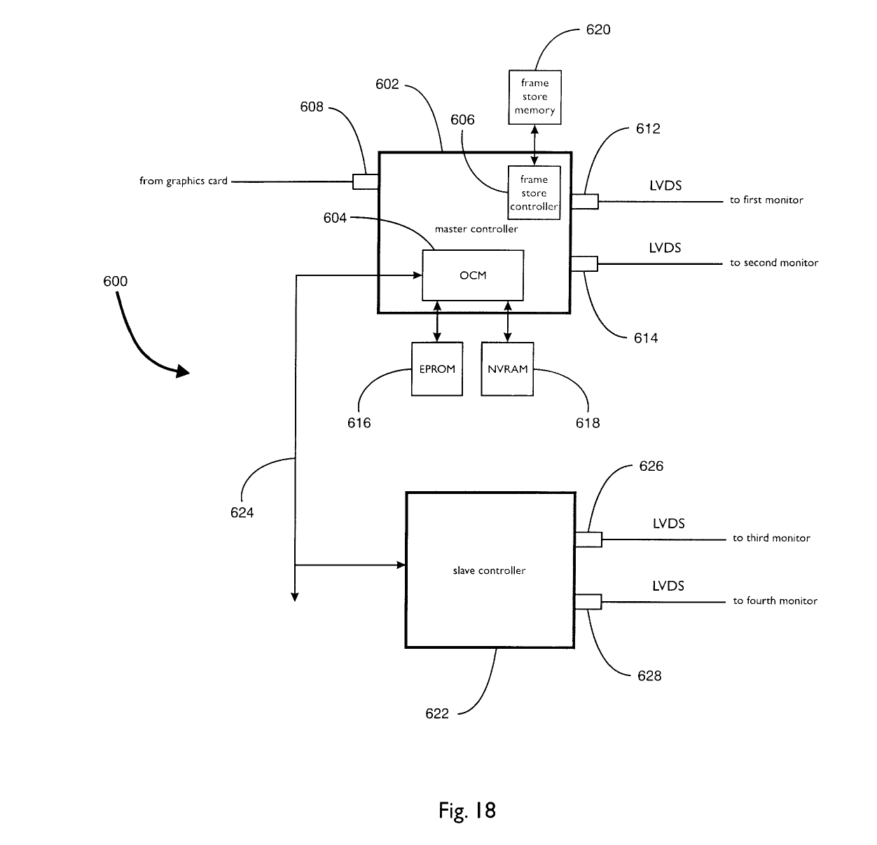

FIG. 18 shows one embodiment of a central controller 600, analogous to the central controller 432, for a four-screen display system, according to the principles of the present invention. The central controller 600 includes a master controller 602 having an on-chip-microcontroller (OCM) 604, a frame store controller 606, an input port 608, and two output ports 612, 614. The central controller 600 also includes a serial EPROM 616, a non-volatile random access memory (NVRAM) 618 and a frame store memory 620, all of which communicate with the master controller 600. In particular, the frame store controller 606 communicates with the frame store memory 620, and the OCM 604 communicates with the EPROM 616 and the NVRAM 618.

The central controller 600 also includes a slave controller 622 connected to the master controller 602 via an expansion bus 624. The slave controller 622 includes two output ports 626 and 628.

In operation, a controller signal, such as a VGA or DVI signal, arrives from the graphics card (not shown in FIG. 18) at the input port 618. In another embodiment (not shown), a second input port is present, so that one port can accept VGA signals and the other port can accept DVI signals, resulting in a central controller that is compatible with more types of graphics cards.

A digital representation of the controller signals is stored in the frame store memory 620. The frame store controller 606 extracts and processes a portion of the stored digital representation. The master controller 602 outputs panel signals, such as LVDS, via the first output port 612 destined for a first panel driver unit of a first monitor (not shown) to produce images on a display screen thereof. Similarly, the master controller 602 outputs panel signals, such as LVDS, via the second output port 614 destined for a second panel driver unit of a second monitor (not shown) to produce images on a display screen thereof.

The save controller 622 is similar to the master controller 602, but is strapped to operate in a slave mode, thus not needing a direct connection to the frame store memory 620, the EPROM 616, or the NVRAM 618. The slave controller 622 outputs panel signals, such as LVDS, via the output port 620 destined for a third panel driver unit of a third monitor (not shown) to produce images on a display screen thereof. Similarly, the slave controller 622 outputs panel signals, such as LVDS, via the output port 628 destined for a fourth panel driver unit of a fourth monitor (not shown) to produce images on a display screen thereof.

The OCM 604 executes a firmware program running from the EPROM 616. The NVRAM 618 stores user settings, such as brightness and/or contrast settings.

The controllers 132, 140, 232, 236, 314, 320, 342, 346, 432, 514, 520, 544 and 600 may possess any number of the following functionalities: an internal A/D converter as part of a VGA interface; an input format detection/auto alignment; an image auto configure; an internal DVI receiver; an on-chip-microcontroller (OCM); a color management unit; an LCD panel gamma correction unit; an on screen display (OSD) controller; a keypad interface; a backlight control unit for sending control signals to one or more backlights; a contrast and color processing unit; an image processing (e.g., scaling, cropping) unit; an internal test signal generator; an LVDS interface; a pin an odd/even swap for layout flexibility; a programmable signal amplitude; a unit for sending power to the screens; and a unit for sending power signals to one or more backlight inverters. In some embodiments, some or all of the aforementioned controllers can possess all of these functionalities.

It should also be understood that the principles of the present invention can be used not only to effectively increase the number of graphics ports from one to N, but to also effectively increase the number of graphics ports from M to N, where M<N. Thus, the principles of the present invention can be applied to a computer having two graphics ports, for supporting two screens, to allow the computer to support three or more screens.

While embodiments of this invention have been illustrated in the accompanying drawings and described above, it will be evident to those skilled in the art that changes and modifications may be made therein without departing from the essence of this invention. For example, the multi-screen graphics apparatus can be spread out over more than one component. For example, a first part of the multi-screen graphics apparatus can be located in the base, and a second part can be located in the column of the display system.

What is claimed is:

1. A multi-screen graphics apparatus for displaying video data on a display system having N>1 screens with respective native resolutions R₁ . . . , R_{N}, the apparatus comprising:
N monitor controllers, each monitor controller associated with one of the N screens for controlling images displayed thereon; and
a replicator for a) receiving from a graphics card a video signal, b) replicating at least a portion of the video signal to produce N sets of video data, and c) sending each of the N sets of video data to an associated one of the N monitor controllers for processing to produce images on the N screens, wherein the video signal and each of the N sets of video data correspond to an effective resolution that is greater than any one of R₁, . . . and R_{N}.

2. The apparatus of claim 1, further comprising a display identification module for sending display identification data to the graphics card to produce the video signal therefrom corresponding to the effective resolution that is greater than any one of R₁, . . . and R_{N}.

3. The apparatus of claim 1 or 2, wherein the display system includes N monitors containing the N screens, and wherein the N monitor controllers are adapted for disposing outside of the N monitors.

4. The apparatus of claim 3, further comprising:
a base;
an arm for supporting the N monitors; and
a column for connecting the base to the arm, wherein at least one of the N monitor controllers is disposed in at least one of the base, the column and the arm.

5. The apparatus of claim 4, wherein each of the N monitor controllers sends video information containing panel signals to an associated one panel driver unit in an associated one of the N monitors, the apparatus further comprising N cables for transmitting the video information.

6. The apparatus of claim 5, wherein the panel signals include one of low voltage differential signals (LVDS) and reduced-swing differential signals (RSDS).

7. The apparatus of claim 3, further comprising a housing for housing the N monitor controllers.

8. The apparatus of claim 7, wherein each of the N monitor controllers solids video information containing panel signals to an associated one panel driver unit in an associated one of the N monitors, the apparatus further comprising N cables for transmitting the video information.

9. The apparatus of claim 8, wherein the panel signals include one of low voltage differential signals (LVDS) and reduced-swing differential signals (RSDS).

10. The apparatus of claim 1 or 2, wherein the display system includes N monitors containing the N screens, and wherein each of the N monitor controllers is adapted for disposing inside an associated one of the N monitors.

11. The apparatus of claim 10, wherein each of the N sets of video data sent by the replicator includes controller signals, the apparatus further comprising N cables for transmitting the N sets of video data to an associated one of the N monitor controllers.

12. The apparatus of claim 11, wherein the controller signals include one of VGA, DVI, HDMI and DisplayPort signals.

13. The apparatus of claim 1, wherein each of the N monitors includes an end monitor controller, and wherein each of the N monitor controllers of the multi-screen graphics apparatus sends video information to an associated one of the N end monitor controllers of the monitors, the video information including controller signals.

14. The apparatus of claim 1, wherein the controller signals include one of VGA, DVI, HDMI and DisplayPort signals.

15. The apparatus of claim 1 or 2, wherein the native resolutions R₁, . . . , R_{N} are substantially equal, and wherein the effective resolution is substantially equal to NR₁.

16. The apparatus of claim 15, wherein R₁ is substantially equal to 1280×1024 pixels.

17. The apparatus of claim 15, wherein the N sets of video data are substantially equal.

18. An apparatus for displaying video data on a display system having N>1 monitors each containing a screen, the respective native resolutions of the N screens being R₁, . . . , R_{N}, the apparatus comprising a central controller for receiving from a graphics card a video signal corresponding to an effective resolution that is greater than any one of R₁, . . . and R_{N}, wherein the central controller divides at least a portion of the video signal into N video streams, each video stream sent to an associated one of the N monitors for producing images on the N screens.

19. The apparatus of claim 18, further comprising a display identification module for sending display identification data to the graphics card to produce the video signal therefrom corresponding to the effective resolution that is greater than one of R₁, . . . and R_{N}.

20. The apparatus of claim 18 or 19, further comprising N panel driver units, one in each of the N monitors, wherein the N panel driver units receive the N video streams from the central controller.

21. The apparatus of claim 20, wherein the central controller sends to N video streams as panel signals, the apparatus further comprising N cables for transmitting the N video streams from the central controller to the N monitors.

22. The apparatus of claim 21, wherein the panel signals includes one of low voltage differential signals (LVDS) and reduced-swing differential signals (RSDS).

23. The apparatus of claim 22, wherein the central controller is adapted for disposing outside of the N monitors.

24. The apparatus of claim 23, further comprising a housing for housing the central controller.

25. The apparatus of claim 23, further comprising:
a base;
an arm for supporting the N monitors; and
a column for connecting the base to the arm, wherein the central controller is disposed in one of the base, the column and the arm.

26. The apparatus of claim 18 or 19, further comprising
N monitors containing the N screens; and
N end monitor controllers disposed in the N monitors, wherein the N video streams are sent from the central controller to the N end monitor controllers for producing the images.

27. The apparatus of claim 26, wherein the central controller sends the N video streams as controller signals, the apparatus further comprising N cables for transmitting the N video streams from the central controller to the N end monitor controllers.

28. The apparatus of claim 27, wherein the controller signals include one of VGA, DVI, HDMI and DisplayPort signals.

29. The apparatus of claim 19, wherein the native resolutions R₁, . . . and R_{N} are substantially equal, and wherein the effective resolution is substantially equal to NR₁.

30. The apparatus of claim 29, wherein R₁ is substantially equal to 1280×1024 pixels.
